(19) United States
(12) Patent Application Publication
(10) Pub. No.: US 2010/0247233 A1
(43) Pub. Date: Sep. 30, 2010

(54) Longitudinal axial securing means for permanently securing a drive-train connection of a vehicle, and a drive-train connection

(76) Inventors: Holger Frank, Friedrichshafen (DE); Jonathan Lipp, Friedrichshafen (DE); Michael Willmann, Bermatingen (DE)

Correspondence Address: COLLARD & ROE, P.C., 1077 NORTHERN BOULEVARD, ROSLYN, NY, 11576, US

(21) Appl. No.: 12/661,806

(22) Filed: Mar. 24, 2010

(30) Foreign Application Priority Data
Mar. 24, 2009 (DE) 10 2009 014 155.3

(51) Int. Cl. F16D 1/12

(52) U.S. Cl. 403/110

(57) ABSTRACT

A longitudinal axial securing device for permanently securing a drive-train connection of a vehicle forms the longitudinal axial securing device as a coupling device, which includes at least one latching tooth. The latching tooth is capable of being inserted radially into the drive-train connection. For this purpose the coupling means includes a tooth support in addition to the at least one latching tooth, the at least one latching tooth being formed in one piece with the tooth support.

### CROSS REFERENCE TO RELATED APPLICATIONS

Applicants claim priority under 35 U.S.C. §119 of German Application No. 10 2009 014 155.3 filed Mar. 24, 2009.

### BACKGROUND OF THE INVENTION

1. Field of the Invention

The invention relates to a longitudinal axial securing means for permanently securing a drive-train connection of a vehicle wherein the longitudinal axial securing means is formed as a coupling means, which comprises at least one latching tooth, the latching tooth being capable of being inserted radially into the drive-train connection. This invention also relates to a drive-train connection with this longitudinal axial securing means, wherein the drive-train connection comprises two structural parts to be coupled, which parts are connected by corresponding toothings so as to rotate together around an axis of rotation.

2. The Prior Art

From DE 103 43 749 B4 there is known a shaft-hub connection with a union collar. This connection couples a flanged element of an insertable shaft and a flanged element of a hollow shaft. Such connections can be used only where the insertable shaft is accessible over its entire circumference from the radial direction in the region of the planned fastening.

Furthermore, from DE 20 09 272 A1 there is known a threadless quick connection for connecting two coaxially oriented parts. In this case the two coaxial parts engage one in the other and are secured in axial direction by a shaped spring. The shaped spring is guided in the outer part in an annular groove and embraces cams formed on the inner part.

From DE 1 854 247 there is known a push-on coupling, which is provided with a radially resilient projection, which engages in a circumferential groove of the power take-off shaft when the coupling is pushed on. The push-on coupling can be engaged and disengaged in the manner of a quick-connect locking means without the use of a tool. This coupling is locked in the pushed-on condition by the automatic engagement of a resilient projection in the circumferential groove of the power take-off shaft.

Finally, from DE 27 47 935 B1 there is known a detachable quick-connect coupling for axially securing a coupling bush on a power take-off shaft. The quick-connect coupling comprises latching members, which are guided through the coupling bush into an annular groove, which is formed on the power take-off shaft, the latching members being embraced by a locking ring, which is retained by a spring.

### SUMMARY OF THE INVENTION

It is an object of the invention to provide a longitudinal axial securing means or drive-train connection with longitudinal axial securing means that can be easily mounted and demounted.

These and other objects are achieved, in one aspect, by a longitudinal axial securing means for permanently securing a drive-train connection of a vehicle in accordance with the invention. The longitudinal axial securing means is formed as a coupling means, which comprises at least one latching tooth. The latching tooth is capable of being inserted radially into the drive-train connection. In addition to the at least one latching tooth, the coupling means comprises a tooth support, the at least one latching tooth being formed in one piece with the tooth support.

In another aspect, the invention achieves these and other objects by a drive-train connection with this longitudinal axial securing means, the drive-train connection comprising two structural parts to be coupled, which parts are connected by corresponding toothings so as to rotate together around an axis of rotation.

Advantageous and practical improvements are discussed below.

The longitudinal axial securing means according to the invention is provided with a coupling means, which comprises a tooth support in addition to the at least one latching tooth. The at least one latching tooth is formed in one piece with the tooth support. By virtue of its one-piece nature, such a one-piece longitudinal axial securing means is easy to handle during mounting and it facilitates compliance with high quality standards, because inadvertent failure to mount add-on structural parts is precluded by the one-piece nature. Correspondingly, demounting is also facilitated, because only the longitudinal axial securing means has to be removed as one integral structural part. The core of the invention is the assembly of individual structural parts to an integral structural group.

The invention further provides for using the longitudinal axial securing means in a drive-train connection, which comprises two structural parts to be coupled. The first structural part is formed in particular as a shaft and the second structural part is formed in particular as an articulated joint. The articulated joint substantially comprises a first articulated-joint part and a second articulated-joint part and the first articulated-joint part is connected to the shaft by corresponding toothings, especially by spline-shaft toothings, so as to rotate therewith around an axis of rotation.

Furthermore, the invention provides for forming the longitudinal axial securing means as a closed ring, which embraces the drive-train connection. In this way, the longitudinal axial securing means can already be pre-mounted simply by pushing it onto the drive-train connection while the drive-train connection is being pushed together.

According to an alternative embodiment, the longitudinal axial securing means is formed as an open clasp or clamp, which can be closed by a locking means. Such a configuration of the longitudinal axial securing means makes it possible to mount the longitudinal axial securing means on a drive-drain connection that has already been pushed together.

The invention further provides for equipping the longitudinal axial securing means with at least one clamping zone and with at least one toothed zone. Because two specialized zones are provided, they can be formed optimally for the two main tasks of the longitudinal axial securing means. These tasks are axial fixation, in the direction of the axis of rotation, of the structural parts connected to rotate together, and securing of these zones on the structural parts by the fixation formed by the latching tooth or teeth, in order to prevent loosening of the fixation.

The invention provides for reducing the diameter of the longitudinal axial securing means from a pre-mounted diameter to a post-mounted diameter, wherein at least one latching tooth is passed for this purpose into an aperture of the first structural part, especially through an aperture in the second structural part. According to a first alternative embodiment, this reduction in diameter is achieved by plastic deformation of the clamping zone of the longitudinal axial securing means. For mounting, such a fixation merely requires a simple crimping operation, in which the tooth support is deformed. According to a second alternative embodiment of the invention, this reduction in diameter is accomplished in particular by use of at least one spring element and elastic deformation of the tooth support. A longitudinal axial securing means fastened in this way can be simply demounted by reverse deformation.

The invention also provides for forming the latching tooth as a wedge. The latching tooth tapers in the direction of the longitudinal axis and the wedge has in particular two oppositely disposed side faces, which have the form of congruent circular sectors. Insertion of the latching tooth into the structural parts is facilitated by this shape. Furthermore, by virtue of this shape, the structural parts are less weakened in their zones close to the longitudinal axis.

Finally, the invention provides for equipping the longitudinal axial securing means with at least two latching teeth, wherein all latching teeth are spaced apart from one another, especially by equal distances. In such axial securing means, the forces developed are uniformly distributed. Furthermore, any imbalance caused by the longitudinal axial securing means is smaller in symmetric longitudinal axial securing means than in longitudinal axial securing means having only one latching tooth or having latching teeth distributed irregularly around the circumference.

The inventive drive-train connection has a coupling means, which comprises one tooth support in addition to at least one latching tooth, wherein the at least one latching tooth is formed in one piece with the tooth support. A drive-train connection with such a longitudinal axial securing means exhibits the previously mentioned advantages.

Within the meaning of the invention, a one-piece longitudinal axial securing means should be understood as a coupling means that is composed of one integral material portion and that was manufactured, for example, as a stamped part, or that is composed of a plurality of material portions of the same or different material, joined together by welding, for example.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 is a partly cutaway schematic diagram showing a cross section through an alternative embodiment of a drive-train connection;

FIG. 2 shows a longitudinal section through the drive-train connection shown in FIG. 1;

FIG. 3 shows the longitudinal axial securing means shown in FIGS. 1 and 2 in a pre-mounted form;

FIGS. 4-7 show schematic alternative embodiments of longitudinal axial securing means; and

FIGS. 8-10 show three views of a longitudinal axial securing means configured according to the alternative embodiment schematically illustrated in FIG. 6.

### DETAILED DESCRIPTION OF PREFERRED EMBODIMENTS

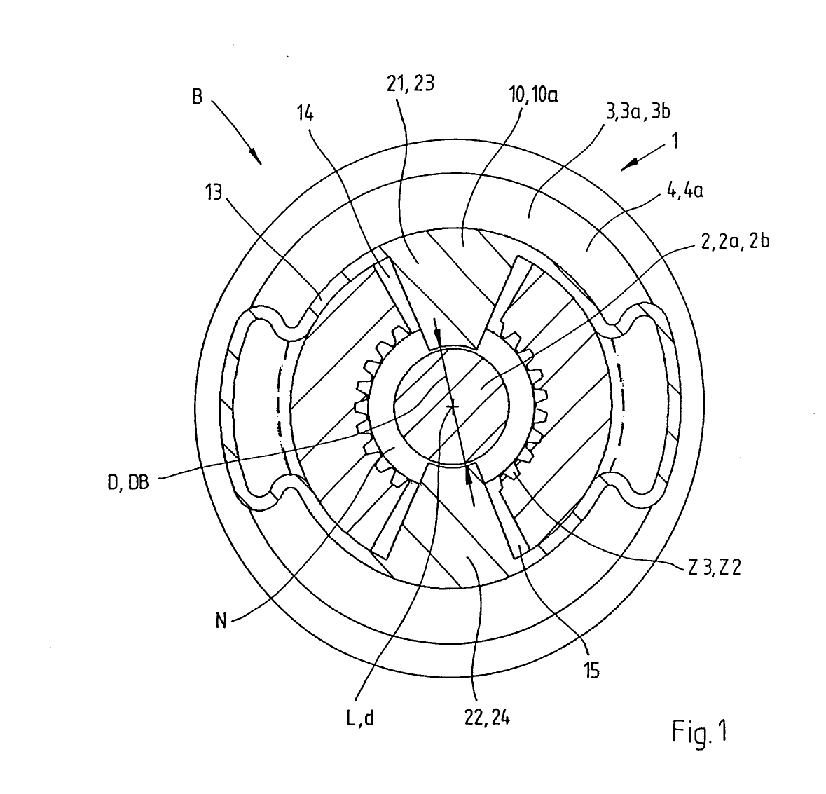

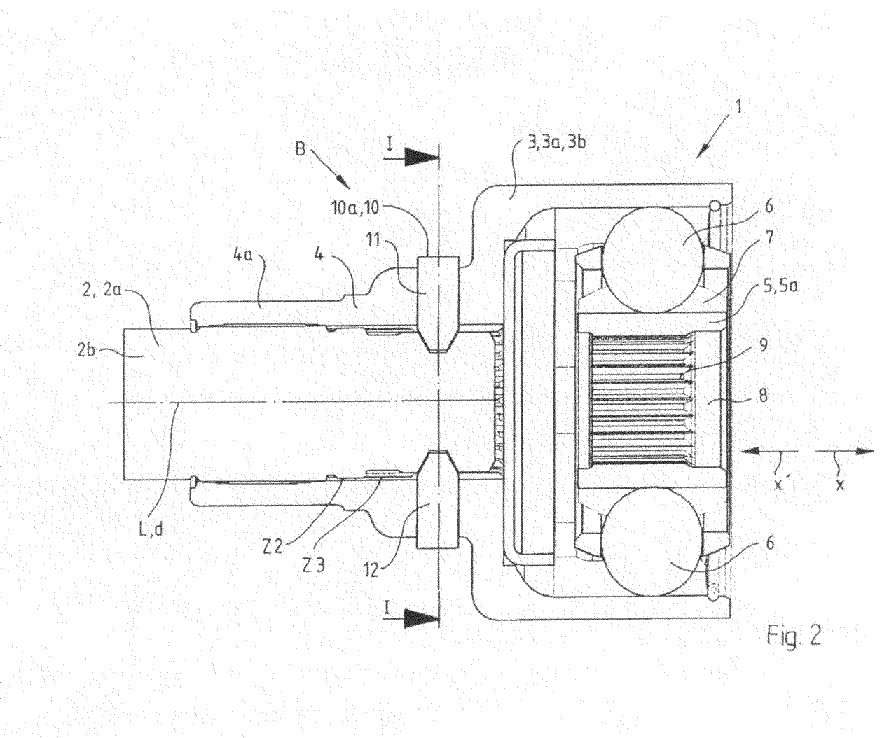

Referring now in detail to the drawings, FIG. 1 shows a cross section through an alternative embodiment of a drive-train connection 1 in a partly cutaway schematic diagram. The section line for this cross section runs according to section line I-I illustrated in FIG. 2. Drive-train connection 1 according to the invention substantially includes a first structural part 2, which is formed as shaft 2a, and a second structural part 3, which is formed as articulated joint 3a. These two structural parts are connected to rotate with one another by corresponding external toothing Z2 of first structural part 2 and internal toothing Z3 of second structural part 3. Shaft 2a is preferably formed as spline shaft 2b and articulated joint 3a is preferably formed as a homokinetic or hypokinetic joint 3b. Articulated joint 3a comprises a first articulated-joint part 4 and a second articulated-joint part 5, wherein first articulated-joint part 4 is formed as an articulated-joint outer part 4a and second articulated-joint part 5 is formed as an articulated-joint inner part 5a. First articulated-joint part 4 is in rotational communication with second articulated-joint part 5 via torque-transmitting balls 6, which are held in a ball cage 7. Articulated-joint inner part 5a has a through bore 8 with a shaft toothing 9, into which a further spline shaft, not illustrated, can be inserted.

Drive-train connection 1 further comprises a first alternative embodiment of a longitudinal axial securing means 10, which is formed as a coupling means 10a. Longitudinal axial securing means 10 comprises two latching teeth 11, 12 and one tooth support 13, which supports the two latching teeth 11, 12. In a mounted condition, in which longitudinal axial securing means 10 is shown in FIGS. 1 and 2, the two latching teeth 11, 12 engage through apertures 14, 15 of articulated-joint part 4 in a groove N, which is formed circumferentially in shaft 2a. These apertures 14, 15 are oriented radially in the direction of a longitudinal axis L or axis of rotation d of shaft 2a. To secure shaft 2a on articulated-joint part 4 with respect to undesired relative movement of shaft 2a or of articulated joint 3a along longitudinal axis L of first or second structural part 2 or 3 in the axial direction of arrow x or x′, latching teeth 11, 12 fix shaft 2a interlockingly on articulated joint 3a. FIGS. 1 and 2 show longitudinal axial securing means 10 in a post-mounted form B, as it appears after having been mounted.

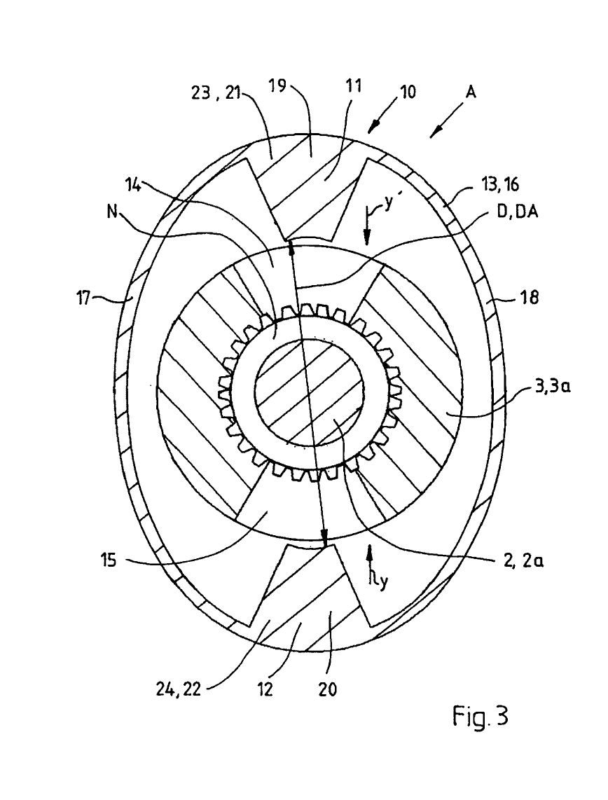

In FIG. 3, longitudinal axial securing means 10 is shown in a pre-mounted form A, as it appears before being mounted. Longitudinal axial securing means 10 is transformed by a plastic deformation operation from the rigid pre-mounted form A to the rigid post-mounted form B. For this purpose tooth support 13, which is formed as a closed ring 16, is deformed in clamping zones 17, 18, which are disposed between tooth zones 19, 20. By means of a tool, not illustrated, clamping zones 17, 18 are deformed from a bow-shaped form, as they appear in FIG. 3, to an OMEGA form, as they appear in FIG. 1. As a result, a diameter D of longitudinal axial securing means 10 measured between latching teeth 11, 12 is reduced from a pre-mounted diameter DA to a post-mounted diameter DB.

During this diameter reduction, brought about by a deformation or crimping operation, latching teeth 11, 12 are inserted in the direction of arrows y′ and y respectively, first into apertures 14, 15 of articulated joint 3a and then into groove N of first structural part 2 or shaft 2a. Circumferential groove N can be made by simple machining during production and is adequate for the intended purpose, because only a longitudinal axial securing means is to be achieved and torque transmission by the longitudinal axial securing means is neither necessary nor intended.

To facilitate insertion during mounting, latching teeth 11, 12 are made in the form of wedges 21, 22, and in the side view of the exemplary embodiment have the form of circular sectors 23, 24. Longitudinal axial securing means 10 is formed as a one-piece coupling means 10a, and is composed of one integral material portion. As an example, this one-piece longitudinal axial securing means 10 can be machined as a stamped part during production.

According to an alternative embodiment of the invention, the longitudinal axial securing means is made of a plurality of material portions of the same material or of different materials, wherein these portions are connected to one another as a one-piece coupling means by a joining process, such as welding and/or riveting.

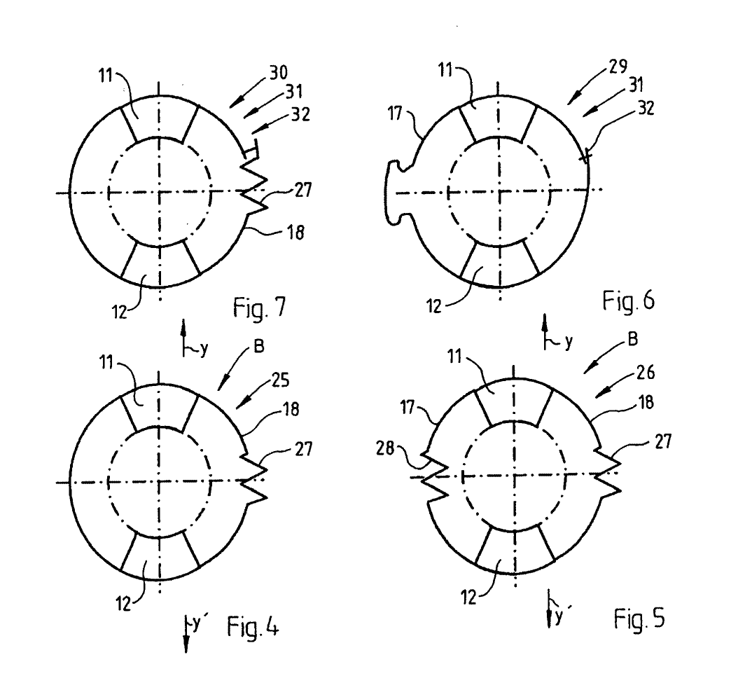

FIGS. 4 to 7 illustrate schematic alternative embodiments of inventive axial securing means.

Longitudinal axial securing means 25, 26 shown in FIGS. 4 and 5, in common with the longitudinal axial securing means shown in FIGS. 1 to 3, are longitudinal axial securing means closed in the form of a ring. In contrast to the first alternative embodiment of a longitudinal axial securing means shown in FIGS. 1 to 3, the second and third alternative embodiments of longitudinal axial securing means 25 and 26 achieve their illustrated post-mounted form B not by plastic deformation but instead by elastic deformation. For this purpose, a clamping zone 18 of longitudinal axial securing means 25 in the second alternative embodiment (see FIG. 4) comprises a schematically illustrated spring element 27, which pulls oppositely disposed latching teeth 11, 12 into the position shown in FIG. 4. In the third alternative embodiment (see FIG. 5), each clamping zone 17, 18 of longitudinal axial securing means 26 has a respective spring element 27, 28, by which latching teeth 11, 12 are pulled into the position shown in FIG. 5. The pre-mounted forms, which are not illustrated but which are also restored by demounting, are achieved by pulling longitudinal axial securing means 25 and 26 apart in the radial direction of arrows y and y′ respectively at latching teeth 11, 12. After the shaft has been extracted from the articulated joint, the axial securing means formed as ring 16 can then be pushed off and removed from the articulated joint, which is not illustrated in FIGS. 4 and 5.

Longitudinal axial securing means 29, 30 shown in FIGS. 6 and 7, in contrast to the longitudinal axial securing means shown in FIGS. 1 to 5, are longitudinal axial securing means formed as open clasps 31 that can be closed in the form of a one-piece ring. Fourth longitudinal axial securing means 29 shown in FIG. 6 has a locking means 32, with which the open clasp can be closed. As an example, mounting is then achieved by placing clasp 31 around the articulated joint, not illustrated, together with the already inserted shaft, closing locking means 32 and deforming longitudinal axial securing means 29 plastically to OMEGA form in a clamping zone 17, thus causing latching teeth 11, 12 to be inserted into the articulated joint and deeper into the shaft.

Fifth longitudinal axial securing means 30 shown in FIG. 7 is formed as clasp 31 and also has a locking means 32, with which this clasp can be closed. As an example, mounting of this longitudinal axial securing means 30 is then achieved by placing clasp 31 around the articulated joint, not illustrated here, together with the already inserted shaft, and closing locking means 32. Because a clamping zone 18 of longitudinal axial securing means 30 comprises a spring element 27, latching teeth 11, 12 are pulled into the articulated joint and deeper into a groove in the shaft during closing of locking means 32. The fifth longitudinal axial securing means is then in the position shown in FIG. 7.

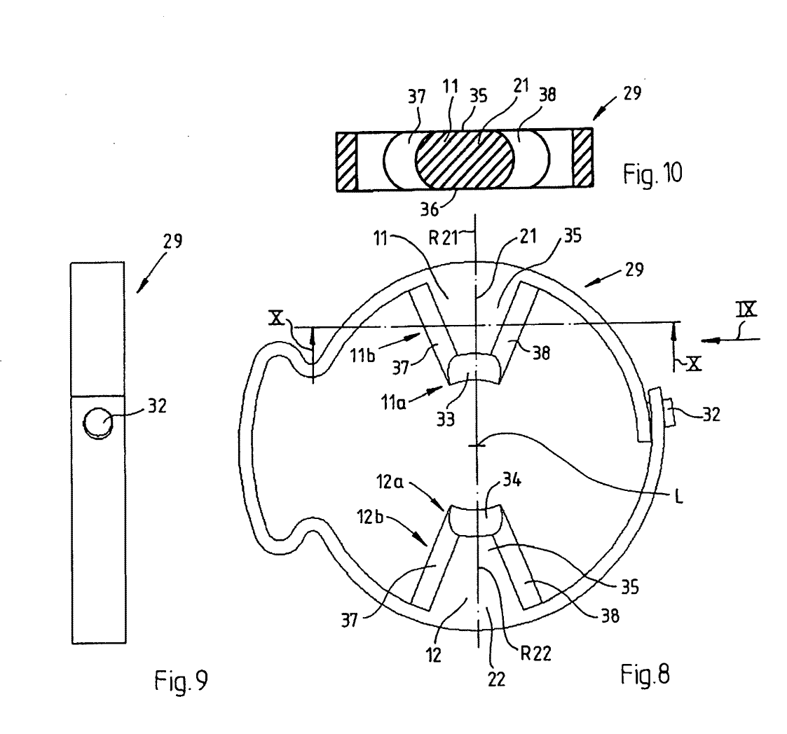

On the basis of the alternative embodiment of a longitudinal axial securing means 29 shown in FIG. 6, FIGS. 8 to 10 show three views of a specific design of this longitudinal axial securing means 29. For this purpose FIG. 8 shows a side view corresponding to FIG. 6, FIG. 9 shows a view of locking means 32 from the direction of arrow IX and FIG. 10 shows a section through longitudinal axial securing means 29 corresponding to section line X-X shown in FIG. 8. Teeth 11 and 12 are formed as wedges 21, 22 in mirror-image relationship, with their tooth tips 11a, 12a shaped as wedge tips 33, 34. These wedge tips 33, 34 are twisted by 90° relative to wedges 21, 22, around radially oriented wedge axes or lines R21, R22 through wedges 21, 22, respectively.

Teeth 11 and 12 are inserted with their wedge tips 33, 34 into a groove of a spline shaft, not illustrated. This groove, which is formed circumferentially in the spline shaft, has a v-shaped cross section, which matches wedges 33, 34 and can be easily machined during production. In the region of tooth stumps 11b, 12b, teeth 11 and 12 have rounded backs 37, 38 between side faces 35, 36 of wedges 21, 22. These backs 37, 38 are oriented in radial direction.

In the mounted condition of longitudinal axial securing means 29, in which this means passes with its teeth 11 and 12 through apertures in an articulated-joint part, not illustrated, tooth stumps 11b, 12b bear with their side faces 35, 36 and their backs 37, 38 flush against the said articulated-joint part. Because longitudinal axial securing means 29 bears flush on the articulated-joint part and on the spline shaft as described, any backlash between the articulated-joint part and the spline part, especially backlash in axial direction, is minimized to the greatest extent possible. Thus longitudinal axial securing means 29 achieves a snug seat of the structural parts to be connected, by having both tooth stumps 11b, 12b of teeth 11, 12 of longitudinal axial securing means 29 and the apertures in the articulated joint match one another and bear flush against one another, as do tooth tips 11a, 12a of teeth 11, 12 of longitudinal axial securing means 29 and the groove in the spline shaft. In this connection, the apertures in the articulated-joint part can also be easily machined during production by guiding a milling tool oriented in radial direction on a circular path around a longitudinal axis L of the articulated-joint part.

Although only a few exemplary embodiments of the present invention have been illustrated or described, it is to be understood that many changes and modifications may be made thereunto without departing from the spirit and scope of the invention.

What is claimed is:

1. A longitudinal axial securing device comprising a coupling drive comprising a tooth support and at least one latching tooth radially insertable into a drive-train connection of a vehicle, wherein the at least one latching tooth is formed in one piece with the tooth support.

2. An assembly comprising:
(a) a drive-train connection of a vehicle comprising first and second structural parts to be coupled, said first structural part being formed as a shaft, said second structural part being formed as an articulated joint comprising a first articulated-joint part and a second articulated-joint part, said first articulated-joint part being connected to the shaft by spline-shaft toothings so as to rotate about an axis of rotation; and
(b) a longitudinal axial securing device for permanently securing the drive-train connection, said longitudinal axial securing device comprising a coupling device comprising a tooth support and at least one latching tooth radially inserted into the drive-train connection, said at least one latching tooth being formed in one piece with the tooth support.

3. The assembly according to claim 2, wherein the longitudinal axial securing device is formed as a closed ring for embracing the drive-train connection.

4. The assembly according to claim 2, further comprising a locking device, wherein the longitudinal axial securing device is formed as an open clasp closeable by the locking device.

5. The longitudinal axial securing device according to claim 1, further comprising at least one clamping zone and at least one toothed zone.

6. The assembly according to claim 2, wherein the longitudinal axial securing device has a reduceable diameter reduceable from a pre-mounted diameter to a post-mounted diameter, the at least one latching tooth passing into a first aperture of the first structural part during reduction of the diameter.

7. The assembly according to claim 6, wherein the at least one latching tooth passes through a second aperture in the second structural part during reduction of the diameter.

8. The assembly according to claim 2, wherein the longitudinal axial securing device has a reduceable diameter and at least one clamping zone plastically deformable at least in some areas in order to reduce the diameter.

9. The assembly according to claim 2, further comprising at least one spring element, wherein the longitudinal axial securing device has a reduceable diameter and at least one clamping zone elastically deformable at least in some areas by the at least one spring element in order to reduce the diameter.

10. The longitudinal axial securing device according to claim 1, wherein the at least one latching tooth is formed as a wedge tapering toward a longitudinal axis, wherein the wedge has first and second oppositely disposed side faces comprising congruent circular sectors.

11. The longitudinal axial securing device according to claim 1, wherein the at least one latching tooth comprises first and second latching teeth spaced apart from one another.

12. The longitudinal axial securing device according to claim 11, wherein the first and second latching teeth are spaced apart from one another by an equal distance.

13. A drive-train connection assembly comprising:
(a) a longitudinal axial securing device comprising a coupling device; and
(b) a drive-train connection comprising first and second structural parts, said first structural part comprising a first toothing, said second structural part comprising a second toothing, said first and second structural parts being connected by the first and second structural toothings so as to rotate together around an axis of rotation;
wherein said coupling device comprises a tooth support and at least one latching tooth formed in one piece with the tooth support and inserted radially into the drive-train connection.

14. The drive-train connection assembly according to claim 13, wherein the longitudinal axial securing device further comprises at least one clamping zone and at least one toothed zone.
